(19) United States
(12) Patent Application Publication
(10) Pub. No.: US 2011/0041291 A1
(43) Pub. Date: Feb. 24, 2011

(54) MULTI-CHANNEL-HINGE

(76) Inventors: Ya-Chen TSENG, Shulin City (TW); Zion Lin, Shulin City (TW)

Correspondence Address: Hershkovitz & Associates, LLC, 2845 Duke Street, Alexandria, VA, 22314, US

(21) Appl. No.: 12/543,489

(22) Filed: Aug. 18, 2009

(51) Int. Cl. E05D 5/10

(52) U.S. Cl. 16/386

(57) ABSTRACT

A multi-channel hinge has a stationary sleeve, multiple resilient spacers and a shaft. The stationary sleeve has an axial gudgeon and multiple channels. Each resilient spacer has a tubular part mounted in the gudgeon, a tab mounted in a corresponding channel and a neck formed between the tubular part and the tab. The shaft is mounted through the tubular parts. Since the necks of the resilient spacers are offset from each other, the spring back forces are separated. Therefore, the spring back angle of the multi-channel hinge is smaller and the multi-channel hinge provides stabler torque.

### BACKGROUND OF THE INVENTION

1. Field of the Invention

The present invention relates to a multi-channel hinge, especially to a multi-channel hinge mounted in a portable electronic device to allow a cover to pivot relative to the base.

2. Description of the Prior Arts

With reference to FIGS. 10 and 11, a conventional hinge is mounted between a cover and a base of a portable electronic device and comprises a stationary sleeve (40), multiple resilient spacers (50) and a shaft (60). The stationary sleeve (40) has a gudgeon (41) and a channel (42) communicating with the gudgeon (41). The resilient spacers (50) are mounted in the gudgeon (41). Each spacer (50) has a C-shaped tubular part (51), a tab (52) and a neck (53). The tab (52) is formed on and protrudes transversely from one end of the tubular part (51). The neck (53) is formed between the tab (52) and the end of the tubular part (51). The tubular parts (51) are mounted in the gudgeon (41) and the tabs (52) engage the channel (42). The shaft (60) penetrates through the tubular parts (51). When the shaft (60) is rotated in the tubular parts (51), friction between the shaft (60) and the tubular parts (51) provides torque to the cover.

However, when the shaft (60) is rotated in the tubular parts (51), the tubular parts (51) are pulled to extend or shrink so that “spring back” forces occur in the necks (53). The spring back forces pull the cover to return to the base. Since the necks (53) align with each other, the spring back forces are concentrate on the same axis. The accumulated spring back forces gradually affect a spring back angle of the cover. Table I is a comparison table of the spring back angle and the number of rotations. The spring back angle is measured on an angle scale.

TABLE I
Comparison table of the spring back angle and the number of
rotations (Prior art)

| Number of rotations | Spring back angle(degree) |
|---|---|
| 5000 | Less than 0.5 |
| 10000 | Less than 0.5 |
| 15000 | Less than 0.5 |
| 20000 | Between 0.5 to 1.5 |
| 25000 | About 1.5 |
| 30000 | Between 1.5 to 3 |
| 35000 | About 3 |
| 40000 | About 3 |

As shown in the table I, as the number of rotations increases, the spring back angle increases. When the number of rotations of the shaft (60) exceeds 35000 times, the spring back angle reaches 3 degrees so that the cover obviously vibrates during pivoting. If the spring back angle is larger, vibration of the cover is more serious during pivoting. The vibration of the cover may cause bumping and noises.

To overcome the shortcomings, the present invention provides a multi-channel hinge to mitigate or obviate the aforementioned problems.

### SUMMARY OF THE INVENTION

The main objective of the present invention is to provide a multi-channel hinge. The multi-channel hinge has a stationary sleeve, multiple resilient spacers and a shaft. The stationary sleeve has an axial gudgeon and multiple channels. Each resilient spacer has a tubular part mounted in the gudgeon, a tab mounted in a corresponding channel and a neck formed between the tubular part and the tab. The shaft is mounted through the tubular parts. Since the necks of the resilient spacers are offset with each other, the spring back forces are separated. Therefore, the spring back angle of the present invention is smaller and present invention provides stabler torque.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a multi-channel hinge in accordance with the present invention;

II FIG. 2 is an end view of the multi-channel hinge in FIG. 1;

FIG. 3 is an exploded perspective view of a second embodiment of a multi-channel hinge in accordance with the present invention;

FIG. 4 is an end view of the multi-channel hinge in FIG. 3;

FIG. 5 is an exploded perspective view of a third embodiment of a multi-channel hinge in accordance with the present invention;

FIG. 6 is an end view of the multi-channel hinge in FIG. 5;

FIG. 7 is an exploded perspective view of a fourth embodiment of a multi-channel hinge in accordance with the present invention;

FIG. 8 is an end view of the multi-channel hinge in FIG. 7;

FIG. 9 is a graph depicting number of rotations plotted against decaying rate;

FIG. 10 is an exploded perspective view of a conventional hinge in accordance with the prior art; and

FIG. 11 is an end view of the conventional hinge in FIG. 10.

### DETAILED DESCRIPTION OF THE PREFERRED EMBODIMENTS

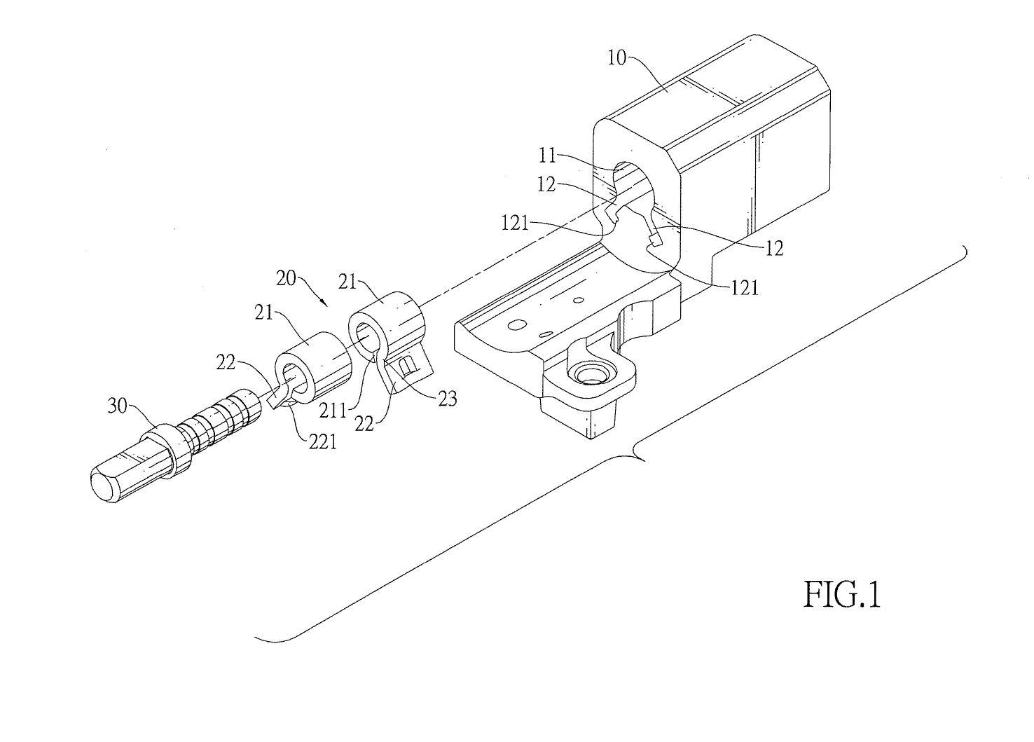

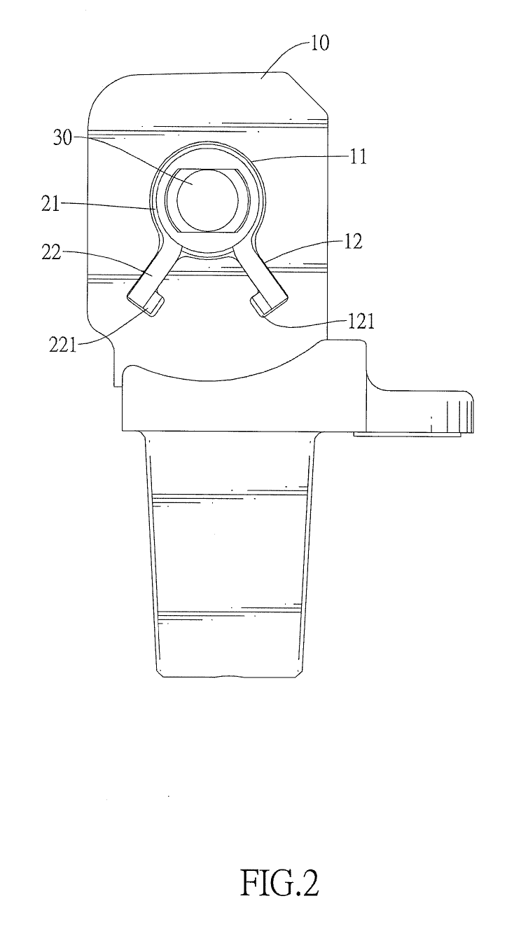

With reference to FIGS. 1 to 8, a multi-channel hinge in accordance with the present invention comprises a stationary sleeve (10, 10A, 10B, 10C), multiple resilient spacers (20) and a shaft (30).

The stationary sleeve (10, 10A, 10B, 10C) is hollow and has an axial gudgeon (11, 11A, 11B, 11C) and multiple channels (12, 12A, 12B, 12C). The channels (12, 12A, 12B, 12C) are formed axially through an inside wall of the stationary sleeve (10, 10A, 10B, 10C), are located radially around the gudgeon (11, 11A, 11B, 11C) and communicate with the gudgeon (11, 11A, 11B, 11C). Each two adjacent channels (12, 12A, 12B, 12C) have an included angle smaller than 180 degrees. Each channel (12, 12A, 12B, 12C) has a perpendicular keyway (121, 121A, 121B, 121C) formed on an end of the channel (12, 12A, 12B, 12C).

The resilient spacers (20) are mounted in the stationary sleeve (10, 10A, 10B, 10C). Each resilient spacer (20) has a tubular part (21), a tab (22) and a neck (23). The tubular part (21) is mounted in the gudgeon (11, 11A, 11B, 11C) of the stationary sleeve (10, 10A, 10B, 10C), is C-shaped and has a slit (211). In a preferred embodiment, the slits (211) of each two adjacent resilient spacers (20) may be toward opposite directions. The tab (22) is formed on and protrudes transversely out from an outside wall of the tubular part (21), is mounted in a corresponding channel (12, 12A, 12B, 12C) of the stationary sleeve (10, 10A, 10B, 10C) and has a key (221). The key (221) is formed on a side of the tab (22) and engages the keyway (121, 121A, 121B, 121C) of the corresponding channel (12, 12A, 12B, 12C). The neck (23) is formed between the tab (22) and the tubular part (21) and is located adjacent to the slit (211). In the preferred embodiment, the resilient spacers (20) correspond in number to the channels (12, 12A, 12B, 12C) so that each tab (22) is mounted in a respective channel (12, 12A, 12C, 12C).

The shaft (30) is mounted rotatably through the tubular parts (21) of the resilient spacers (20) and abuts an inside wall of each tubular part (21).

With reference to FIGS. 1 and 2, in a preferred embodiment, the stationary sleeve (10) has two channels (12). The channels (12) have an included angle between 76 degrees and 90 degrees. The tabs (22) of two resilient spacers (20) are mounted respectively in the channels (12).

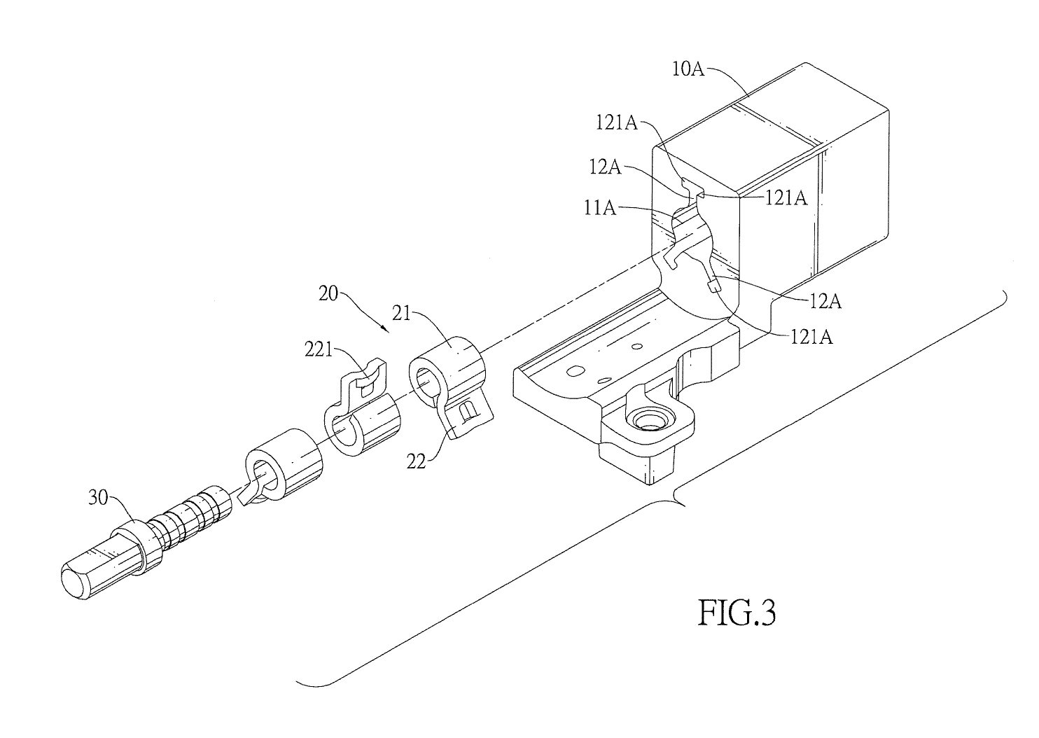

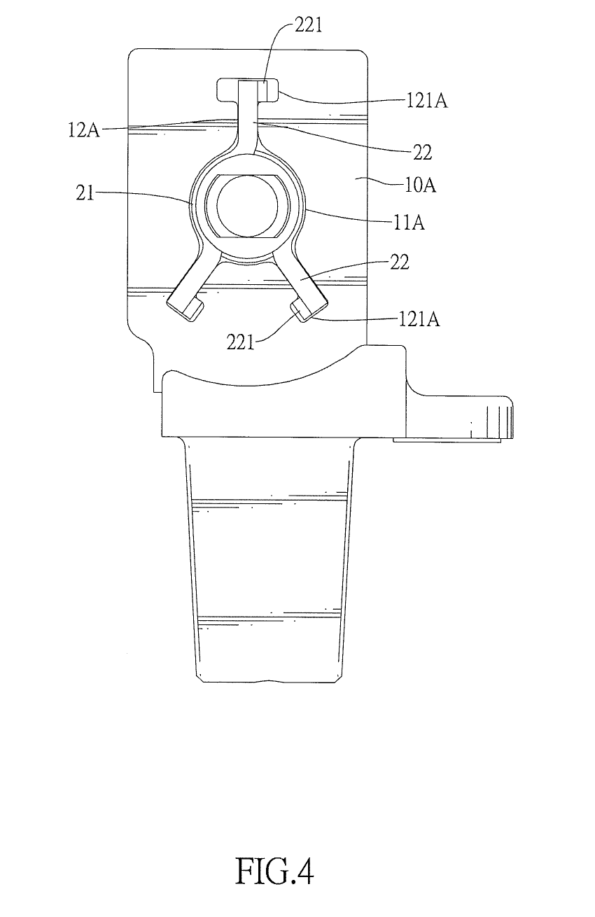

With reference to FIGS. 3 and 4, in another preferred embodiment, the stationary sleeve (10A) has three channels (12A). The adjacent channels (12A) have included angle of about 120 degrees. The tabs (22) of three resilient spacers (20) are mounted respectively in the channels (12A).

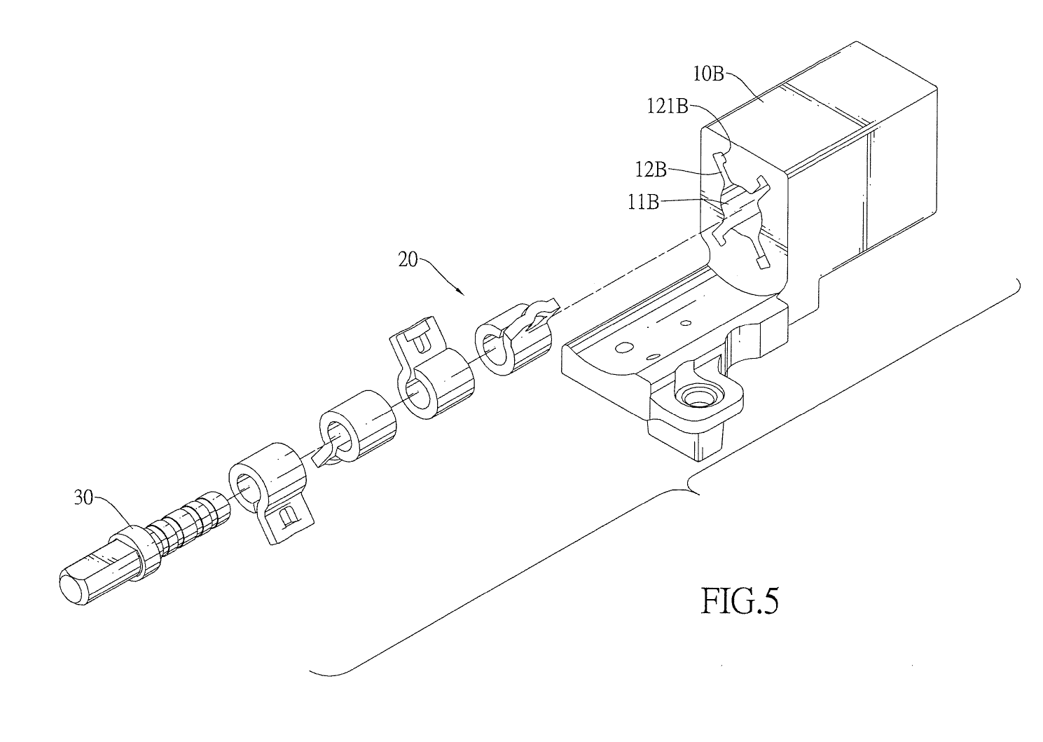

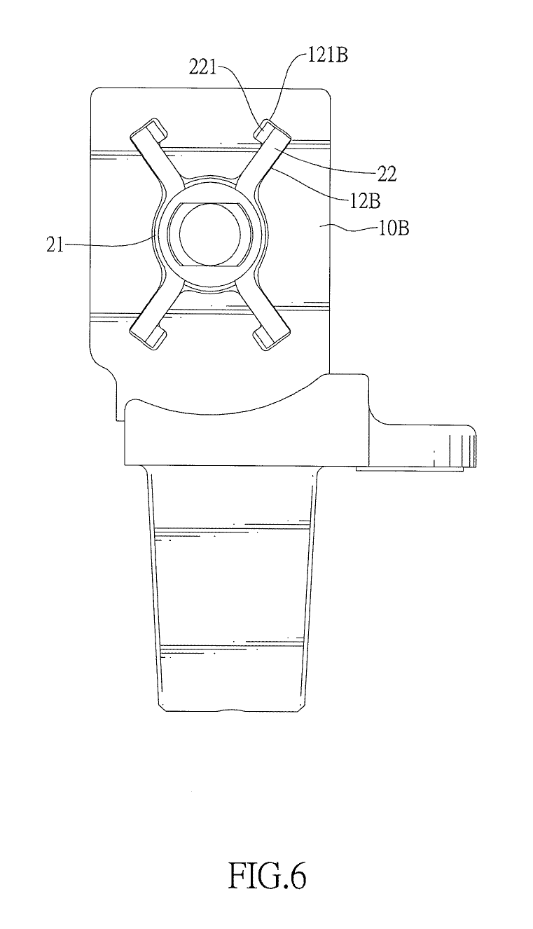

With reference to FIGS. 5 and 6, in another preferred embodiment, the stationary sleeve (10B) has four channels (12B). The adjacent channels (12B) have included angle of about 90 degrees. The tabs (22) of four resilient spacers (20) are mounted respectively in the channels (12A).

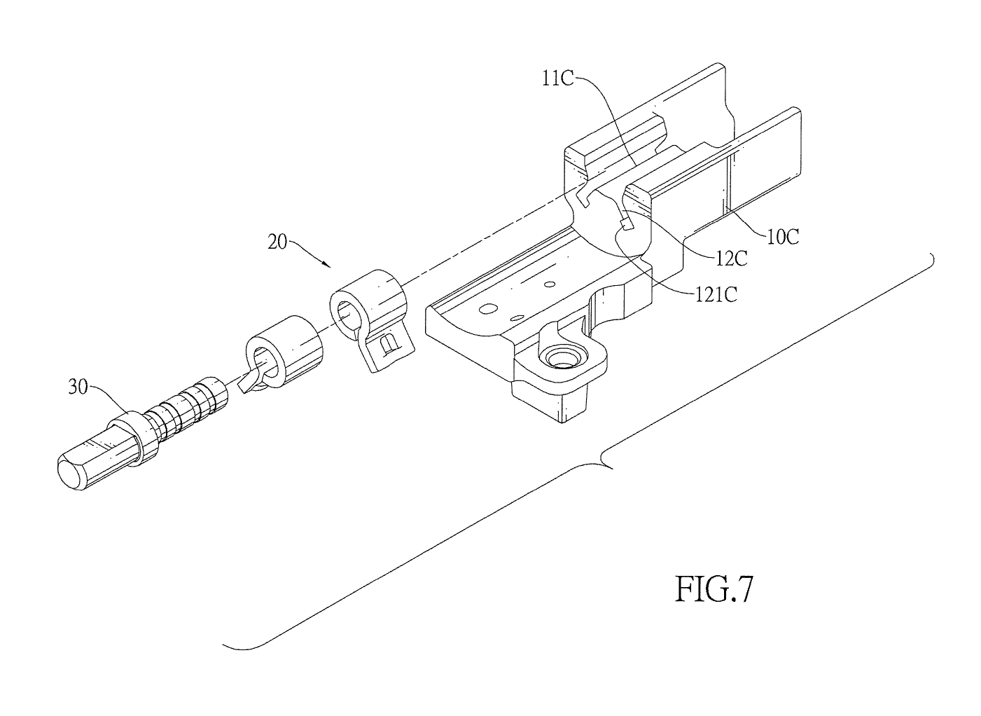

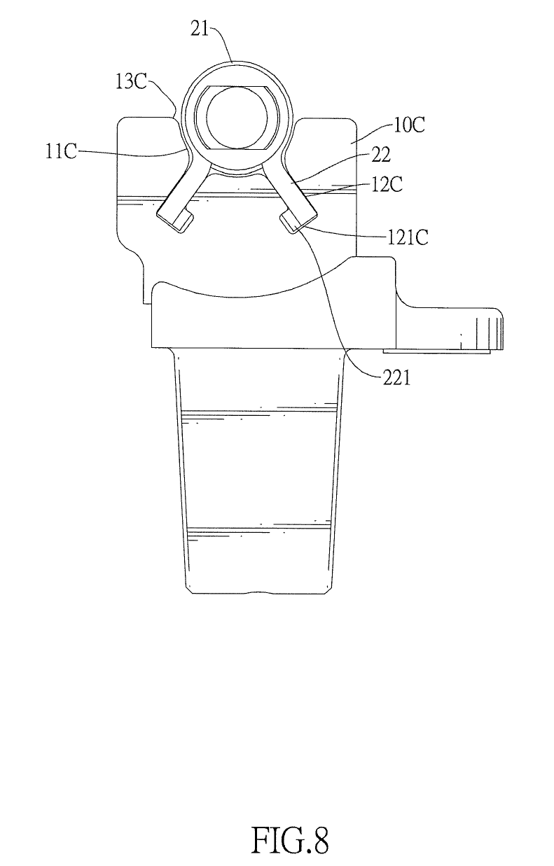

With reference to FIGS. 7 and 8, in another preferred embodiment, the stationary sleeve (10C) has two channels (12C) and a top opening (13C). The top opening (13C) communicates with the gudgeon (11C). The tubular parts (21) of the resilient spacers (20) protrude through the top opening (13C). The tabs (22) of two resilient spacers (20) are mounted respectively in the channels (12C).

With reference to FIGS. 1 and 2, the hinge as described may be mounted in a portable electronic device with a cover and a base. The shaft (30) is attached securely to the cover, and the stationary sleeve (10) is attached securely to the base. When the cover is pivoted, the shaft (30) is rotated relative to the resilient spacers (20) and the shaft (30) rubs against the inside walls of the tubular parts (21) to provide torque. Since the tabs (22) are mounted in different channels (12), the necks (23) of the resilient spacers (20) are offset from each other. That is to say, two resilient spacers (20) are respectively mounted in the corresponding channels (12) as shown in FIG. 2 so as to having different axes. Therefore, the spring back forces applied to the necks (23) are separated on different axes, which effectively reduces the effect of the spring back force.

TABLE II
Comparison table of the spring back angle and the number of
rotations (Present invention)

| Number of rotations | Spring back angle (degree) |
|---|---|
| 5000 | Less than 0.5 |
| 10000 | Less than 0.5 |
| 15000 | Less than 0.5 |
| 20000 | Less than 0.5 |
| 25000 | Less than 0.5 |
| 30000 | Less than 0.5 |
| 35000 | Less than 0.5 |
| 40000 | Less than 0.5 |
| 45000 | Less than 0.5 |
| 50000 | Less than 0.5 |
| 55000 | Less than 0.5 |
| 60000 | Less than 0.5 |

Table II shows results of experiments performed on the first embodiment of the present invention shown in FIGS. 1 and 2. Even though the number of rotations of the shaft (30) reaches 60000, the spring back angle is still less than 0.5 degrees so that the vibration of the cover is barely perceivable.

Furthermore, the torque providing by the hinge in accordance with the present invention is stabler than the torque providing by the conventional hinge. The decaying rate C of the torque is based on a first torque A that is generated when the shaft (30) is rotated first time. The following torque B minus the first torque A and then divided by A equal to the decaying rate C. The formula is shown as following:

(B−A)/A=C

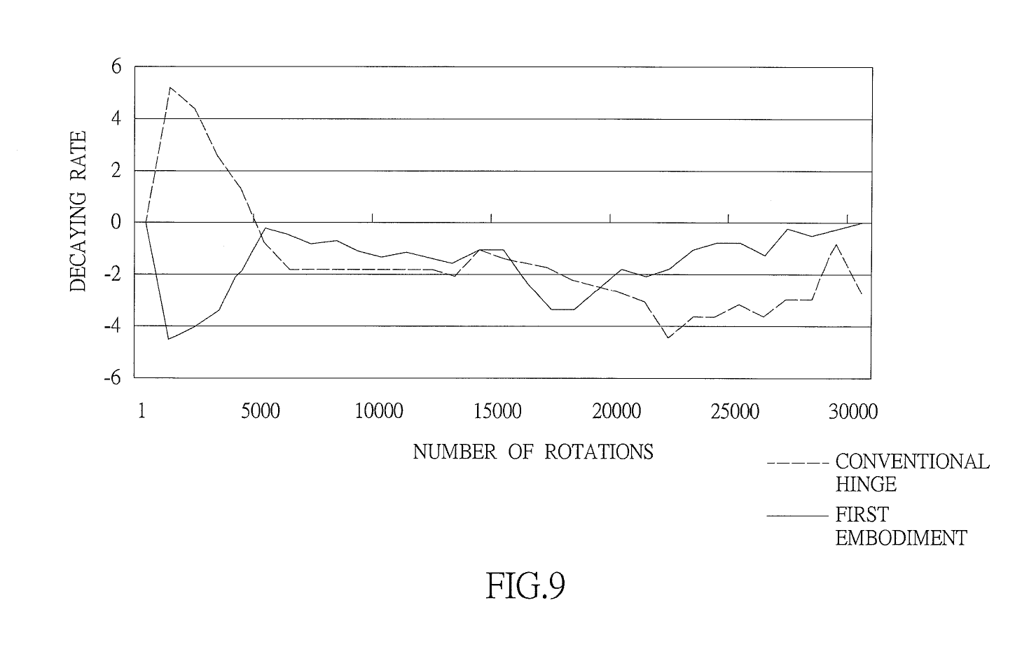

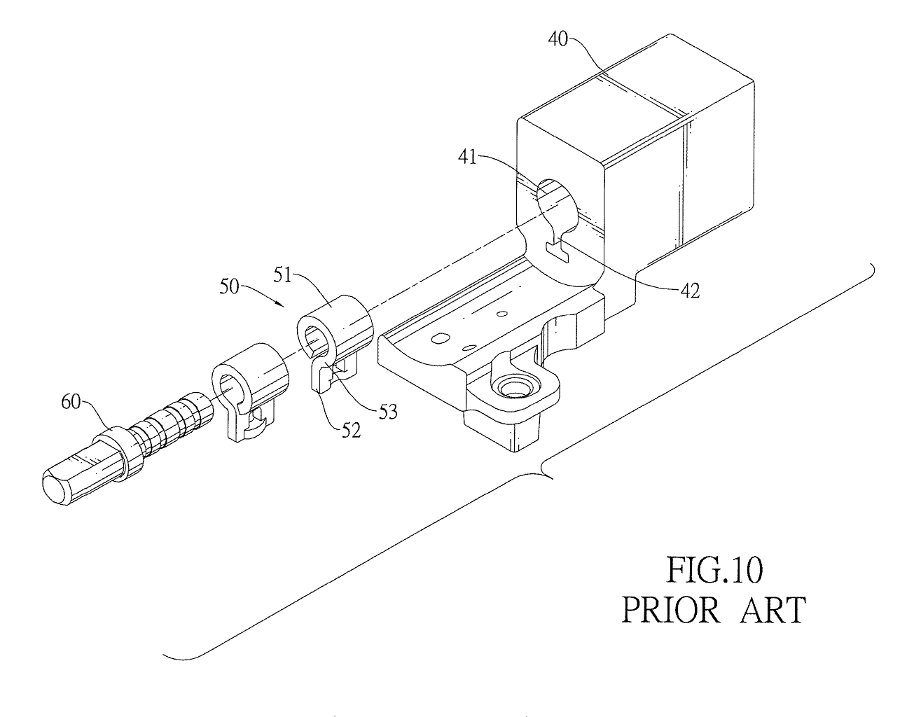

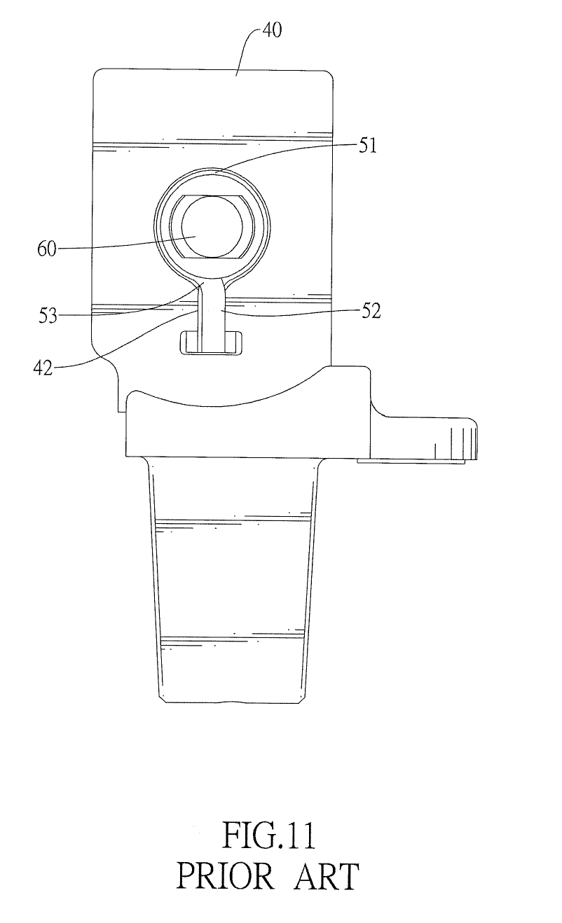

With reference to FIG. 9, the decaying rate of the first embodiment of the present invention is shown as solid line and the decaying rate of the conventional hinge is shown as dotted line. The variation of the decaying rate of the convention hinge is obviously larger than the variation of the decaying rate of the first embodiment of the present invention. Furthermore, the decaying rate of the first embodiment of the present invention remains between 0 to −2 even after 20 000 rotations. On the contrary, the decaying rate of the conventional hinge averages −3 after 20 000 rotations. Therefore, the present invention provides stabler torque than the conventional hinge.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A multi-channel hinge comprising:
a hollow stationary sleeve having
an axial gudgeon;
multiple channels formed axially through an inside wall of the stationary sleeve, located radially around the gudgeon and communicating with the gudgeon;
multiple resilient spacers mounted in the stationary sleeve, each resilient spacer being mounted in a corresponding channel of the stationary sleeve, and having
a tubular part mounted in the gudgeon of the stationary sleeve, being C-shaped and having a slit;
a tab formed on and protruding transversely out from an outside wall of the tubular part, mounted in the corresponding channel of the stationary sleeve; and
a neck formed between the tab and the tubular part and located adjacent to the slit;
a shaft mounted through the tubular parts of the resilient spacers.

2. The multi-channel hinge as claimed in claim 1, wherein the stationary sleeve has two channels and the multi-channel hinge has two resilient spacers.

3. The multi-channel hinge as claimed in claim 2, wherein
the stationary sleeve has a top opening communicating with the gudgeon; and
the tubular parts of the resilient spacers protrude through the top opening.

4. The multi-channel hinge as claimed in claim 1, wherein the resilient spacers correspond in number to the channels of the stationary sleeve.

5. The multi-channel hinge as claimed in claim 1, wherein the stationary sleeve has three channels and the multi-channel hinge has three resilient spacers.

6. The multi-channel hinge as claimed in claim 1, wherein the stationary sleeve has four channels and the multi-channel hinge has four resilient spacers.

7. The multi-channel hinge as claimed in claim 1, wherein the slits of each two adjacent resilient spacers are toward opposite directions.

8. The multi-channel hinge as claimed in claim 1, wherein
each channel of the stationary sleeve has a perpendicular keyway formed on an end of the channel; and
the tab of each resilient spacer has a key formed on a side of the tab and engaging the keyway of the corresponding channel.

9. The multi-channel hinge as claimed in claim 2, wherein
each channel of the stationary sleeve has a perpendicular keyway formed on an end of the channel; and
the tab of each resilient spacer has a key formed on a side of the tab and engaging the keyway of the corresponding channel.

10. The multi-channel hinge as claimed in claim 3, wherein
each channel of the stationary sleeve has a perpendicular keyway formed on an end of the channel; and
the tab of each resilient spacer has a key formed on a side of the tab and engaging the keyway of the corresponding channel.

11. The multi-channel hinge as claimed in claim 4, wherein
each channel of the stationary sleeve has a perpendicular keyway formed on an end of the channel; and
the tab of each resilient spacer has a key formed on a side of the tab and engaging the keyway of the corresponding channel.

12. The multi-channel hinge as claimed in claim 5, wherein
each channel of the stationary sleeve has a perpendicular keyway formed on an end of the channel; and
the tab of each resilient spacer has a key formed on a side of the tab and engaging the keyway of the corresponding channel.

13. The multi-channel hinge as claimed in claim 6, wherein
each channel of the stationary sleeve has a perpendicular keyway formed on an end of the channel; and
the tab of each resilient spacer has a key formed on a side of the tab and engaging the keyway of the corresponding channel.

14. The multi-channel hinge as claimed in claim 7, wherein
each channel of the stationary sleeve has a perpendicular keyway formed on an end of the channel; and
the tab of each resilient spacer has a key formed on a side of the tab and engaging the keyway of the corresponding channel.
